(19) United States
(12) Patent Application Publication
(10) Pub. No.: US 2024/0240035 A1
(43) Pub. Date: Jul. 18, 2024

(54) PACKAGING MATERIAL HAVING ANTI-MICROBIAL PROPERTIES

(71) Applicant: SOREMARTEC S.A., Senningerberg (LU)

(72) Inventors: Igor ROMANO, Olm (LU); Emma-Rose JANECEK, Schoos (LU)

(73) Assignee: SOREMARTEC S.A., Senningerberg (LU)

(21) Appl. No.: 18/559,454

(22) PCT Filed: May 6, 2022
(86) PCT No.: PCT/EP2022/062242

§ 371 Date: Nov. 7, 2023

(30) Foreign Application Priority Data
May 7, 2021 (LU) 500140

(51) Int. Cl. C09D 5/14; C08J 7/04; C08J 7/043; C08K 3/08; C09D 7/61; C09D 7/65; C09D 101/16; C09D 105/08; C09D 133/08; C09D 137/00; C09D 167/02; C09D 183/04

(52) U.S. Cl. CPC C09D 5/14; C08J 7/0423; C08J 7/043; C08K 3/08; C09D 7/61; C09D 7/65; C09D 101/16; C09D 105/08; C09D 133/08; C09D 137/00; C09D 167/02; C09D 183/04; C08J 2323/12; C08J 2401/16; C08J 2405/08; C08J 2433/08; C08J 2467/03; C08J 2475/04; C08J 2483/04; C08K 2003/0806

(57) ABSTRACT

A packaging with anti-microbial properties has a substrate, and a coating having a first polymeric component selected from the group consisting of polyacrylic resins, polyvinyl butyral polyurethanes, polyesters, polyvinyl alcohols, cellulosic polymers and mixtures thereof, a low adhesion, slip or release agent selected from the group consisting of polysiloxanes, carnauba wax, lecithin, fatty acids, fatty acid amides, fatty acid esters, magnesium stearate, vegetable oils, and mixtures thereof, an anti-microbial agent, and optionally one or more functional agents selected from the group consisting of a defoaming agent, a coalescing agent, a wetting agent, a cross-linking agent, and mixtures thereof. The coating has from 50 to 99.49% by weight of the first polymeric component, from 0.5 to 35% by weight of the low adhesion, slip or release agent, from 0.01 to 15% by weight of the anti-microbial agent, and from 0 to 10% by weight of functional agents, the percentage

The present invention relates to a packaging material having anti-microbial properties, particularly anti-viral properties.

Particularly, the invention relates to a packaging material for use in the packaging of food products.

Packaging is designed to contain and protect its content from the external environment, thus acting as a barrier; moreover, it has an important role as a surface for communication to the customers; therefore, packaging has to be viewed as both a barrier and a surface, both aspects being relevant from a safety perspective.

When a surface is exposed to the environment outside of controlled manufacturing, it will collect a build-up of debris that can include diseases causing microbes. This can include droplets containing microbes or more specifically viruses which fall into the packaging surface and remain for a while. The practice of sanitizing surfaces can prevent the risk of disease transmission by deactivating the microbes, but this is not always possible outside of production facilities and along the supply chain towards the market place and households. For this reason, active surfaces able to combat microbial contaminations are appealing and add value to customers.

Since a packaging surface is exposed to the environment throughout the distribution chain and yet challenging to sanitize once it has left the production facilities, an anti-microbial, active packaging surface is desirable and would reduce the risk of disease transmission from humans to surfaces, and surfaces to humans, thus protecting the supply chain and the final customer. Sustained and robust anti-microbial activity of the packaging surface throughout the lifetime of packaging is essential to ensure protection along the supply chain towards customers' houses through warehouses and point of sales

Moreover, it is desirable to eliminate or minimize migration of the anti-microbial agent towards the external environment, so as to prolong the anti-microbial and active effect against any disease potential transmitted by touching packaging surfaces. Therefore, specific formulations have to be put in place to enable the packaging to maintain activity from production date to expiry date

An object of the present invention is to provide packaging and/or a packaging material with improved anti-microbial properties suitable to reduce the risk of disease transmission through contact with the packaging surface.

Particularly, an object of the invention is to provide packaging which prevents or reduces microbial and virus adhesion to the packaging surface by debris, droplets or whatever carrier attach to the surface, through non-stick, low adhesion or slip properties and that, at the same time, inhibits microbial infection by de-activating any remaining adhered microbes (anti-microbial properties). The invention also applies to packaging which are to be distributed through a cold chain, since, storage in refrigerated conditions, in some cases, may prolong the activity of the infectious agents.

It is thus an object of the present invention packaging as defined in the appended claims, which are to be considered as included in the present disclosure.

### SUMMARY OF THE INVENTION

The subject-matter of the invention is packaging, as defined in the appended claims, having anti-microbial properties, antiviral properties, and also the ability to make droplets and debris slip away or adhere less, comprising a substrate and a coating, wherein said coating combines anti-microbial properties with low adhesion properties. The low adhesion, slip or release properties of the coating act to reduce the build-up of contamination on the packaging surface while the anti-microbial behavior acts to deactivate microbes present in any residual contamination.

The term “packaging(s)”, as used herein, applies to packaging sheets or films having a flexible substrate and to packaging having a rigid or self-supporting substrate, such as containers and the like.

This invention provides a wide field of active coating surfaces that can be applied on any kind of packaging including packaging obtained by extrusion and injection molding such as protecting trays, boxes and whatever packaging having a semi-rigid or rigid consistency and appearance. Moreover, this invention, thanks to specific additional discovered properties by the coating formulated can also give sealability to packaging film surfaces, and on materials after thermoforming. This unlocks the possibility to produce combined packaging and boxes with flexible elements sealed to rigid parts giving a wider field of active surfaces towards selling proposition and customers.

In some embodiments of the invention relating to heat sealable coatings, sealing mediated by the coating can occur at temperatures from 70-150° C. and times of 25 ms to 20 sec depending on substrate. Preferably around 100° C. and 0.5 sec. The coating can, when applicable, lower the sealing temperature of plastic substrates enabling sealing at lower temperatures or shortening the time needed for complete sealing.

The coating comprises:
A first polymeric component selected from the group consisting of, polyacrylic resins polyvinyl butyral, polyurethanes, polyvinyl alcohols (fully hydrolyzed (DH>98) or partially hydrolyzed), cellulosic polymers, polyesters, preferably selected from polyhydroxyalkanoates, polybutylene succinate and polylactic acid, and mixtures thereof;
a low adhesion, slip or release agent selected from the group consisting of, polysiloxanes, polyethylene glycol, polyethylene, carnauba wax, lecithin, polyamides, fatty acid amides, fatty acids, fatty acid esters, magnesium stearate, vegetable oils, paraffin waxes and mixtures thereof; and
an anti-microbial agent.

The formulation may additionally include one or more of the following functional agents:
a defoaming agent
a coalescing agent
a wetting agent
a cross-linking agent
and mixtures thereof

In the coating composition, the first polymeric component is generally the major component, in terms of weight, and alone or in combination with the low adhesion, slip or release agent forms a continuous phase or matrix, in which the anti-microbial agent is dispersed or dissolved.

Polyacrylic resins for use as the first polymeric component include polyacrylic acid, polyacrylates and polymethacrylate.

Polyester resins for use as the first polymeric component include, polyethylene terephthalate, polyhydroxyalkanoates, polycaprolactone, polybutylene succinate, polylactic acid or mixtures thereof.

Preferred polyhydroxyalkanoates include lactic acid polyesters, polyhydroxybutyrate, polyhydroxybutyrate-valerate, polyhydroxybutyrate-propanoate, polyhydroxybutyrate-hexanoate, polyhydroxybutyrate-decanoate, polyhydroxy-butyrate-dodecanoate, polyhydroxybutyrate-hexadecanoate, polyhydroxybutyrate-octadecanoate, poly-3-hydroxybutyrate-4-hydroxybutyrate, poly-3-hydroxybutyrate-co-3-hydroxyhexanoate or mixtures thereof.

Cellulosic polymers include cellulose, nitrocellulose, chitosan, cellulose acetate, carboxy methyl cellulose, methoxycellulose, hydroxymethyl cellulose, cellulose acetate butyrate, cellulose acetate propionate, cellulose-2-hydroxyethylmethyl ether, cellulose-hexadecyl 2-hydroxyethyl ether, cellulose acetate butanoate or mixtures thereof.

Whereas the first polymeric component may be hydrophobic or hydrophilic, the low adhesion, slip or release agent is generally a hydrophobic or super-hydrophobic material or substance or an amphiphilic like material or substance.

The terms “hydrophobic” and “super-hydrophobic”, as used herein, mean water repellant, and have their usual and ordinary meaning in the chemical and polymer arts. In particular, as used herein with respect to materials, the term “hydrophobic” means that the material has a contact angle with water of at least 90 degrees. and the term “super-hydrophobic” means that it has a contact angle higher than 150 degrees.

The term amphiphilic as used herein, means a substance having both hydrophobic and hydrophilic parts and has its usual and ordinary meaning in the chemical and polymer arts.

Preferred polysiloxanes include dimethylpolysiloxane, silicone vinyl polymers, silicone emulsions and silicone oils and alkylated siloxane polymers (or silicone wax) and mixtures thereof. Particularly preferred are dimethylpolysiloxane and silicone wax and mixtures of them.

Preferred vegetable oils include, soybean oil, castor oil, rapeseed oil, palm oil, sunflower oil, and coconut oil and mixtures thereof.

Suitable anti-microbial agents for use according to the invention include metals (such as titanium, silver, gold, copper, platinum, zinc), oxides or salts of said metals, alloys, glasses or clays comprising said metal oxides or salts; said metals may be in the form of nanoparticles or may be supported on nano-, micro- or macro-silica or silicone based or clay based supports; also included as anti-microbial agents are anti-microbial peptides, silicone based anti-microbial agents and quaternary ammonia cations (Qua Ts).

Moreover, anti-microbial agents may also take the form of disinfectants, optionally encapsulated within heat, moisture or temperature-sensitive polymers. Disinfectants can include peroxides, propylene glycol, triethylene glycol, dodecanoic acid, formaldehyde, glutaldehyde, thymol, clove oil, cinnamon oil, grape fruit extract, eucalyptus extract, anti-microbial plant extract, chlorine, or iodine solutions in solvents, such as water, ethanol, isopropanol or mixtures thereof.

Preferred anti-microbial agents comprise, silver ion materials such as silver chloride, titanium, silver phosphate, zinc oxide, silicone tethered quaternary amine, thymol, clove oil, cinnamon oil, grape fruit seed extract, eucalyptus extract or a mixture of the preceding.

In all embodiments silver ion is a preferred anti-microbial agent.

The coating is formulated as a solution, dispersion, suspension or melt including the first polymeric component, the low adhesion component, the anti-microbial agent and when appropriate a suitable solvent. Suitable solvent includes water, ethyl acetate, ethanol, isopropanol, methanol, hexadecane, dodecane and mixtures thereof.

The coating solution, dispersion or slurry may have a dry content of from 0.5 to 70% by weight; dry contents of from 10 to 25% by weight, more preferably of about 15% by weight are preferred.

The loading of the anti-microbial component in the coating solution or dispersion can be from 0.001% to 60% of the dry content, preferably from 0.01 to 15% by weight of the final formulation.

Following the coating and drying process the solvent retention of the residual coating should preferably be less than 15 g/sqm independent of the solvent and substrate combination used.

Suitable coating methods according to the invention include rotogravure, flexographic, offset, digital printing and extrusion-coating. The combination of the first polymeric component, anti-microbial agent and low adhesion, slip or release component can also be extruded and/or injected.

In the case of rotogravure printing cylinders should be engraved such that the coating weight dry grammages in the following range are achieved:
0.1-20 g/sqm

The cylinder for rotogravure can be engraved by any kind of technology, like helio, electrocutions or laser.

In case of flexo printing, anilox engraving will be leveraged taking into account continuous engaging techniques to avoid discontinuity during flexo printing.

The coating providing the anti-microbial properties can be applied in one pass or several passes.

The coating of the invention can be applied directly onto the surface of a packaging material substrate or it can be applied on top of or in combination with inks, barrier coatings for moisture or oxygen resistance, sealing lacquers, release lacquers, low adhesion or food contact lacquers enabling the combination of properties and various packaging stratigraphies.

In a preferred embodiment the packaging comprises one or a plurality of adhesion enhancing layers placed between the substrate and the anti-microbial coating. The adhesion enhancing layers prepare the surface to receive the coating and lead to improved functionality. They act by improving the adhesion of the coating to the substrate and help to keep the coating at the surface, preventing it from been removed through the delamination, abrasion or absorption into the substrate. The effect of keeping the coating on the surface leads to enhanced functionality since the coating properties are maintained for a longer time along the supply chain of the packaging; moreover, the same performances can be achieved with a lower amount of coating since more is available at the surface of the packaging.

Adhesion enhancing layers include printed layers with printing inks, clay coatings, barrier coatings and primer layers or coatings.

Inks and primers can change the surface energy of the substrate enhancing coating adhesion. Clay and other barrier coatings will also change the surface energy of the substrate and can additionally reduce the porosity of the substrate increasing the availability of the coating at the surface of the packaging without increasing the amount applied.

During the printing process, it is often the case that one layer is not fully dried and/or cured before the next layer is applied on top. This means that once the structure is fully assembled, further drying/curing occurs with various chemical and physical interactions between the layers of this structure. This curing is a temporary state which can be considered complete within 24-72 hours depending on the specific primers, inks or varnishes that are used. This curing and the interactions, once the system is assembled, were found to further enhance the activity of the coating layer in addition to the improved adhesion described above.

Suitable primers include an acrylic varnish, preferably with added isocyanate, optionally in combination with a layer printed with printing inks.

In the coating composition, after curing and/or drying, the weight amounts of the first polymeric component, low adhesion, slip or release agent and anti-microbial agent are preferably such as to obtain a hydrophobic surface. In the cases where the first polymeric component is not itself hydrophobic the low adhesion, slip or release agent must be present in sufficiently high concentrations at the surface of the coating to provide a hydrophobic surface. Typically, this is achieved by a low adhesion, slip or release agent, which during the drying or curing process migrates to the surface of the coating thus providing the coating with enhance concentrations of this material compared to the coating bulk leading to a hydrophobic surface. Accordingly, a minor component of the low adhesion, slip or release agent is enough to provide a hydrophobic surface.

In general, the coating comprises when dry, after curing and post converting process:
from 50 to 99.49% by weight of the first polymeric component; preferably 70% to 99.49%
from 0.5 to 35% by weight of the low adhesion, slip or release component, preferably 1% to 10%; and
from 0.01 to 15% by weight of the anti-microbial agent, preferably 0.01% to 10% more preferably 0.01%-2%, the percentages by weight being referred to 100 parts by weight of the dry coating, whereby the percentages sum up to 100%.

Suitable materials for the substrate comprise paper, paperboard, glass, metal and plastic materials such as, particularly, polypropylene (PP), polyethylene (PE), polyethylene-polypropylene copolymers, polystyrene (PS), polyethylene terephthalate (PET) and bioplastics, such as polyhydroxyalkanoates (PHA), polybutylene succinate (PBS) or polylactic acid (PLA).

In one embodiment the substrate comprises a film or sheet made or comprising the above-mentioned materials and such films or sheets having a metal coating. The packaging substrate also includes multiple layer laminates of the above-mentioned films or sheets and laminates including polymeric layers laminated with or coated onto paper. Said films or sheets may or may not be compostable and/or biodegradable in multiple environments.

Substrates in the form of a film or sheet, may have a heat sealable coating; in the case of a flexible substrate with a heat sealable coating, the coated substrate may be sealed against other surfaces, such as a tray or a box, or it may be folded, e.g. in a tubular form, to obtain a packaging having the anti-microbial coating on the external side thereof or on the inside. Said substrate in the form of a film or sheet may be thermoformable and the anti-microbial coating may be applied to the substrate, before thermoforming to obtain a shaped packaging structure.

As mentioned before, the term “packaging”, as used herein, also includes packaging wherein the substrate is a shaped structure such as rigid or semi-rigid containers, boxes or cartoons, either of glass, metal, plastic, paper or paperboard. Such materials may be formed by injection molding, thermoforming, folding or other suitable forming techniques.

In the case of thermoformed and folded rigid or semi-rigid substrates, the coating can be printed or sprayed onto the substrate whilst flat. The anti-microbial activity of the coating is then maintained during the folding or thermoforming processing or becomes activated through this process, thus imparting on the rigid or semi-rigid structure anti-microbial activity. Suitable substrates for this process include paper and paperboard, polypropylene, polyethylene, polyethylene-polypropylene copolymers, ABS, polyethylene terephthalate, polystyrene, polylactic acid, polybutyl succinate, polyhydroxyalkanoates.

As mentioned below the coating composition comprising the first polymeric component, the anti-microbial agent and the low adhesion, slip or release component can also be extruded, co-extruded and injected, with anti-microbial properties maintained after the thermal processing resulting in rigid or semi-rigid anti-microbial packaging.

Suitable polymers for injection molding in combination with the coating composition comprising said first polymeric component, the anti-microbial component and the low adhesion, slip or release agent, include: polypropylene, polyethylene, polyethylene-polypropylene copolymers, ABS, polyethylene terephthalate, polystyrene, polylactic acid, polybutyl succinate, polyhydroxyalkanoates.

According to an embodiment of the invention, the packaging comprises a substrate which is an injection molded or extruded packaging structure obtained by injection molding or extruding a polymer blend comprising:
a polymer selected from the group consisting of polypropylene, polyethylene, polyethylene-polypropylene copolymers, ABS, polystyrene, polyethylene terephthalate and bioplastics, preferably polyhydroxyalkanoates, polybutylene succinate or polylactic acid, and mixtures thereof and components of the coating composition comprising the anti-microbial agent and the low adhesion, slip or release agent, as previously defined and optionally said first polymeric component, as previously defined.

The components of the coating composition comprising the anti-microbial agent, the low adhesion, slip or release agent and optionally said first polymeric component can either be compounded and directly extruded or injected with a suitable polymer for injection molding, such as those mentioned in the preceding paragraph or they can be compounded with a carrier resin to form a master batch which is later injected or extruded with said suitable polymer.

In a preferred embodiment, the master batch should be added at 0.1 to 10% wt. into the injection molding polymer, the master batch comprising:
from 45 to 97% by weight of the carrier polymer (injection molding resins); preferably 80% to 97%
from 1 to 30% by weight of the first polymeric component
from 1 to 5% by weight of the low adhesion, slip or release agent, preferably 1% to 3%; and
from 1 to 20% by weight of the anti-microbial agent, preferably 1% to 10%

The formulation may additionally include
nucleating agents and
surfactant and stabilizing agents

In the case the materials are combined without the use of a master batch the following is a preferred embodiment:
from 73% to 99.399% by weight of the injection molding polymer,
from 0.5% to 20% by weight of said first polymeric component,
from 0.1% to 2% by weight of the low adhesion, slip or release agent, preferably less than 1.5%; and
from 0.001 to 5% by weight of the anti-microbial agent, preferably 0.1% to 1%.

Depending on the choice of the substrate, the coating, as before described, can be applied directly to an untreated packaging surface or to the surface which has been previously treated such as by corona treatment, primers, inks and the like. Following the application of the coating curing must occur eliminating the solvent from the coating when present and enabling either physical or chemical crosslinking. Extended curing times at elevated temperatures may be necessary to stabilize the coating behavior.

According to the invention, the use of a coating, including the above-mentioned low adhesion, slip or release components, provides a packaging surface with reduced adhesion of water droplets and other debris which in turn reduces the accumulation and residency time of microbes. This acts together with the anti-microbial properties of the coating leading to enhanced anti-microbial properties and a reduction in loading of anti-microbial agents. The combined benefits of anti-microbial properties with release or slip properties additionally can facilitate the unwinding of coated reel of materials.

### SUMMARY DESCRIPTION OF THE DRAWINGS

FIGS. 1 to 6 of the annexed drawings show, by way of example, preferred layered structures of the packagings of the invention.

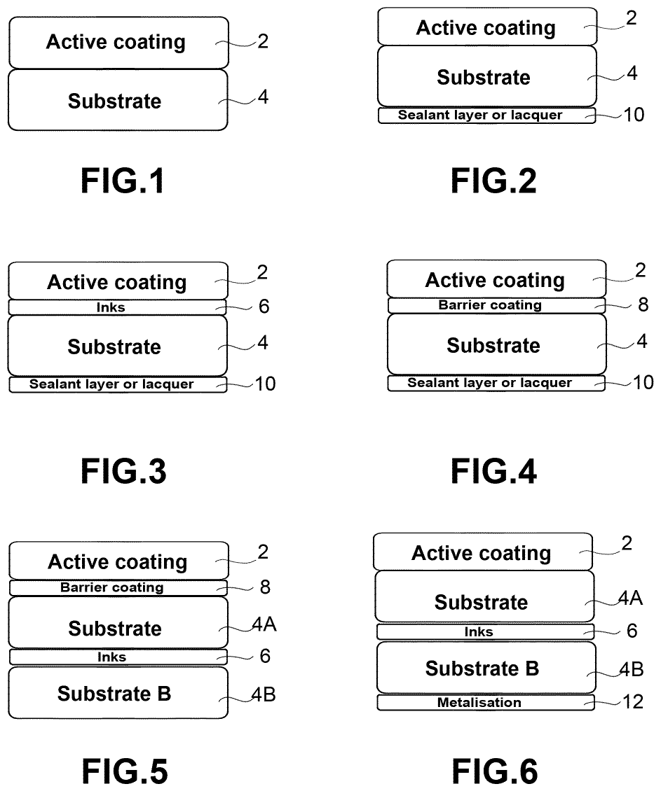

The active coating layer 2 is applied on the substrate 4 as the outermost layer of the packaging structure, optionally with an interposed ink or printed layer 6 or with an interposed barrier coating layer 8. A sealant layer or lacquer layer 10, suitable to provide heat sealing properties, may be applied on the other side of the packaging opposite the active coating layer. However, in some embodiments, the active coating layer may be heat sealable. A metallization layer 12 may be applied on the external surface of the packaging opposite the active coating layer. The packaging may include one or more substrate layers 4A and 4B.

### PREFERRED EMBODIMENTS OF THE INVENTION

The disclosure of the components of the coating layer provided hereinbefore, is to be construed as a disclosure of the specific combination of each of the listed polymeric components with each of the listed slip or release agents and/or each of the listed antimicrobial agents.

In preferred embodiments, that provide a coating layer suitable for rotogravure printing, followed by heat sealing of the coated surface the polymeric component is preferably an acrylic, polyurethane or cellulosic polymer.

In this embodiment, the preferred low adhesion, slip or release agent is selected from the group consisting of polysiloxanes, such as silicone vinyl polymers, silicone emulsions, dimethyl polysiloxanes, silicone oils and alkylated silicone polymers (or silicone wax), polyethylene glycol, polyethylene, carnauba wax, lecithin, polyamides, fatty acids, fatty acid esters, magnesium stearate, vegetable oils, such as soybean oil, rapeseed oil, palm oil, sunflower oil, coconut oil and castor oil, paraffin waxes and mixtures thereof.

Any of the antimicrobial agents, mentioned herein before can be combined with the each of the above-mentioned polymeric components and/or slip or release agents; however, the antimicrobial agent is preferably selected from silver chloride, titanium, silver phosphate, silicone tethered quaternary amine, zinc oxide, anti-microbial plant extract or a mixture thereof. In these embodiments the coating composition is preferably formulated in an aqueous solvent.

The ranges for the weight amounts of the components of the coating composition, disclosed hereinbefore, also apply to the components according to the preferred embodiments that follow.

Preferred embodiments are also packagings having a coating wherein:
A) the first polymeric component is an acrylic polymer or, polyvinyl butyral,
   the slip or release agent is selected from the following: paraffin wax, silicone containing polymers, carnauba wax or plant-based oil
   the antimicrobial agent is silver ions, preferably formulated in an aqueous solvent.
B) the first polymeric component is an acrylic or polyurethane polymer,
   the slip or release agent is selected from paraffin wax, silicone containing polymers, carnauba wax or vegetable oil,
   the antimicrobial agent is silver phosphate glass; the coating being preferably formulated in an aqueous solvent.
C) the first polymeric component is an acrylic or a polyurethane polymer,
   the slip or release agent is selected from paraffin wax or silicone containing polymers
   the antimicrobial agent is silver phosphate ceramic; preferably formulated in an aqueous solvent.
D) the first polymeric component is a cellulosic polymer,
   the slip or release agent is selected from paraffin wax or silicone containing polymers, coconut oil, carnauba wax or vegetable oils, preferably coconut oil,
   the antimicrobial agent is silver phosphate ceramic; preferably formulated in an aqueous solvent.
E) the first polymeric component is a cellulosic polymer,
   the slip or release agent is selected from paraffin wax or silicone containing polymers, carnauba wax, vegetable oils, preferably coconut oil,
   the antimicrobial agent is thymol, cinnamon oil, clove oil or mixtures thereof; preferably formulated in an aqueous solvent.

Further preferred embodiments, wherein the coating layer is suitable to be printed by rotogravure, but is not suitable for heat sealing due to the presence of chemical crosslinking, are packagings wherein the first polymeric component of the coating is polyester, polyvinyl butyral, polyurethane or cellulosic polymer particularly packagings wherein in the coating:
F) the first polymeric component is polyester, polyvinyl butyral, polyurethane or cellulosic polymer,
   the slip or release agent is selected from paraffin wax, silicone containing polymers, carnauba wax, polyamide and mixtures thereof,
   the antimicrobial agent is selected from silver chloride, titanium, silver phosphate, silicone tethered quaternary amine or a mixture thereof wherein the coating composition preferably comprises an isocyanate or aldehyde derivative based crosslinking agent. These coatings are preferably formulated with ethyl acetate as the solvent.
G) the first polymeric component is polyester, polyvinyl butyral, polyurethane or cellulosic polymer,
   the slip or release agent is selected from paraffin wax, carnauba wax, coconut oil, polyamide and mixtures thereof,
   the antimicrobial agent is a silicone tethered quaternary amine or a mixture of silver chloride, titanium, silver phosphate, silicone tethered quaternary amine, anti-microbial plant extract, wherein the coating composition preferably comprises an isocyanate or aldehyde derivative based crosslinking agent. These coatings are preferably formulated with ethyl acetate as the solvent.

In the following working examples, percentages are by weight unless otherwise indicated.

### Example 1

A coating was prepared comprising:
nitrocellulose based polymer (85% referred to dry substance)
silicone containing polymer 7% referred to dry substance
silver ions 1% referred to dry substance
functional agents (7% referred to dry substance)
with ethyl acetate (85% referred to the total of the above dry components).

The coating was applied by rotogravure on a film of polypropylene or polyethylene as the substrate; coating weight of 0.5-3 g/sqm, 250 m/min line speed, followed by curing for 24 h at ambient temperatures. Resulted in virucidal activity with an R value >1 when tested against Influenza A and NL63 human corona virus according to ISO21702:2019 with 24 h contact time.

### Example 2

A coating was prepared comprising:
polyester (91% referred to dry substance)
poly dimethyl siloxane 7%, silicone tethered quaternary amine 0.02% to 2% dry content
with isocyanate based crosslinking agent and
with ethyl acetate as the solvent, (40% to the total of the above dry components).

The coating was applied by rotogravure technology to a film of polypropylene or polyethylene, coating weight of 0.5-2.5 g/sqm, 200 m/min line speed, isocyanate crosslinking, followed by curing at ambient temperatures for 72 h. Resulted in virucidal activity with an R value >1 when tested against NL63 human corona virus according to ISO21702:2019 with 24 h contact time.

### Example 3

A coating was prepared comprising:
polyurethane (92% referred to dry substance)
carnauba wax 7%
silver ions 1%
with aqueous solvent (85% referred to the total of the above dry components).

The coating was applied by rotogravure technology to a polypropylene film with a coating weight of between 1 and 3 g/sqm. Resulted in virucidal activity with an R value >2 when tested against Feline Calicivirus according to ISO21702:2019 with 24 h contact time.

### Example 4

A coating was prepared comprising:
acrylic polymer (90-92.9% referred to dry substance)
vegetable oil (7% referred to dry substance)
silver ions (0.1-3% referred to dry substance)
with aqueous solvent (85% referred to the total of the above dry components).

The coating was applied to a polypropylene film using rotogravure technology with a coating weight of between 1 and 2 g/sqm. Resulted in anti-bacterial activity with >3 log reduction when tested against E. coli. and S. aureus according to ISO22196 with 24 h contact time.

### Example 5

A coating was prepared comprising:
chitosan (90-92.9% referred to dry substance)
coconut oil (7% referred to dry substance)
a mixture of clove, cinnamon and thymol oils (0.1-3% referred to dry substance)
with aqueous solvent (85% referred to the total of the above dry components).

The coating was applied manually to a polypropylene film with a coating weight of between 1 and 4 g/sqm and resulted in delayed mold growth.

### Example 6

On a paper substrate (weight 60 g/m²) a clay coating was applied and the clay coating was then printed 1 to 9 colors by sequential rotogravure printing; the following antimicrobial coating was then applied onto the printed layer:
Acrylic polymers (90% referred to dry substance)
Polysiloxane (4% referred to dry substance)
Silver ions on inorganic support (1.4% referred to dry substance)
Functional agents (4.6% referred to dry substance)
With aqueous solvent (70% referred to the total of the above dry components).

The coating was applied at 1.4-2 g/m² by rotogravure technology and resulting in a >2 log reduction in bacteria when tested against E. coli and S. aureus according to ISO22196 with 24 h contact time.

### Example 6a

The procedure of Example 6 was repeated using as the substrate a polypropylene film. Substantially the same results in terms of antibacterial activity, according to ISO 22196, were achieved.

### Example 7

A substrate consisting of an aluminum film was printed with 7 colors by rotogravure and the following anti-microbial coating was applied:
Polyvinyl butyral (92% referred to dry substance)
Polysiloxane (4% referred to dry substance)
Silver ions on inorganic support (0.8% referred to dry substance)
Functional agents (3.2% referred to dry substance)
With ethyl acetate solvent (75% referred to the total of the above dry components) and crosslinking agent (15% with respect to coating formulation described above)

The coating was applied at 1.4-2 g/m² by rotogravure technology at 180 m/min and resulting in a >4 log reduction in bacteria when tested against E. coli and S. aureus according to ISO22196 with 24 h contact time and >1 log reduction in viral titer according to ISO21702 with 24 h contact time.

### Example 8

A substrate consisting of a polypropylene film was printed with a primer layer at 0.2 to 1.5 g/m², consisting of an acrylic varnish with added isocyanate; a printed layer with printing inks was applied onto the primer layer, according to the needs of the graphic. The following anti-microbial coating was then applied onto the printed layer.
Acrylic polymers (90% referred to dry substance)
Fatty acids (4% referred to dry substance)
Silver ions on a solid support (1% referred to dry substance)
Functional agents (5% referred to dry substance)
With aqueous solvent (70% referred to the total of the above dry components).

It was found that the curing of the coating when applied on top of the primer and inks acted to enhance the anti-microbial activity of the coating itself.

### Example 9

A coating was prepared comprising:
Acrylate polymers (90% referred to dry substance)
Polysiloxane/Silicon wax (4% referred to dry substance)
Silver ions on inorganic support (1.4% referred to dry substance)
Functional agents (4.6% referred to dry substance)
With aqueous solvent (70% referred to the total of the above dry components).

### Example 10

A coating was prepared comprising:
Polyvinyl butyral (92% referred to dry substance)
Polysiloxane/silicon wax (4% referred to dry substance)
Silver ions on inorganic support (0.8% referred to dry substance)
Functional agents (3.2% referred to dry substance)
With ethyl acetate solvent (75% referred to the total of the above dry components) and crosslinking agent (15% with respect to coating formulation described above)

1. A packaging having anti-microbial properties, the packaging comprising a substrate and a coating, wherein said coating comprises:
a first polymeric component selected from the group consisting of polyacrylic resins, polyvinyl butyral, polyurethanes, polyvinyl alcohols, cellulosic polymers and polyesters;
a low adhesion, slip or release agent selected from the group consisting of polysiloxanes, carnauba wax, lecithin, fatty acids, fatty acid amides, fatty acid esters, magnesium stearate, vegetable oils, and mixtures thereof,
an anti-microbial agent, and
optionally one or more functional agents selected from the group consisting of:
a defoaming agent,
a coalescing agent,
a wetting agent,
a cross-linking agent,
and mixtures thereof,
wherein said coating comprises:
from 50 to 99.49% by weight of the first polymeric component;
from 0.5 to 35% by weight of the low adhesion, slip or release agent, and
from 0.01 to 15% by weight of the anti-microbial agent, and
from 0 to 10% by weight of the one or more functional agents,
the percentages by weight being referred to 100 parts by weight of a dry coating.

2. The packaging of claim 1 wherein said first polymeric component is a polyacrylic resin and said low adhesion, slip or release agent is a polysiloxane, preferably a mixture of dimethylpolysiloxane and silicone wax.

3. The packaging of claim 1, wherein said first polymeric component is polyvinyl butyral and said low adhesion, slip or release agent is a polysiloxane, preferably a mixture of dimethylpolysiloxane and silicone wax.

4. The packaging of claim 1, wherein said polyacrylic is resins are selected from polyacrylic acid, polyacrylates, and polymethacrylates.

5. The packaging of claim 1, wherein said polysiloxane is polysiloxanes are selected from the group consisting of dimethylpolysiloxane, silicone vinyl polymers, silicone emulsions, silicone oils, silicone wax, and mixtures thereof.

6. The packaging of claim 1 wherein said polyesters are selected from the group consisting of polyhydroxyalkanoates, polyethylene terephthalate, polycaprolactone, polybutylene succinate, polyvinyl succinate, polylactic acid, and mixtures thereof.

7. The packaging of claim 1 wherein said vegetable oils are selected from the group consisting of soybean oil, castor oil, rapeseed oil, palm oil, sunflower oil, coconut oil, and mixtures thereof.

8. The packaging of claim 1, wherein said anti-microbial agent is a metal selected from the group consisting of titanium, silver, gold, copper, platinum, and zinc, an oxide or salt of said metals, alloys, glasses or clays comprising said metal oxides, and wherein said metals may be in the form of nanoparticles or may be supported on nano-, micro- or macro-silica, silicone or clay supports.

9. The packaging of claim 1, wherein said anti-microbial agent is selected from the group consisting of anti-microbial peptides, silicone based anti-microbial agents and quaternary ammonium cations (Quats).

10. The packaging of claim 1, wherein said anti-microbial agent is a disinfectant selected from the group consisting of peroxides, propylene glycol, triethylene glycol, dodecanoic acid, formaldehyde, glutaraldehyde, thymol, clove oil, cinnamon oil, grape fruit seed extract, eucalyptus extract, anti-microbial plant extract, chlorine, or iodine solutions in solvents, such as water, ethanol, isopropanol or mixtures thereof, and wherein said disinfectant is optionally encapsulated within a heat, moisture or temperature sensitive polymeric material.

11. The packaging of claim 1, wherein said coating is obtained from a solution or dispersion including said first polymeric component, said low adhesion, slip or release agent and said anti-microbial agent and a solvent selected from the group consisting of water, ethyl acetate, ethanol, isopropanol, methanol, hexadecane, dodecane, and mixtures thereof.

12. The packaging of claim 1, wherein in said coating:
the first polymeric component is a polyester,
the low adhesion, slip or release agent is selected from polysiloxanes, carnauba wax, fatty acids, fatty acids amides, and mixtures thereof, and
the anti-microbial agent is selected from silver chloride, titanium, silver phosphate, silicone tethered quaternary amine, thymol, grape fruit seed extract, clove oil, cinnamon oil or a mixture thereof, said coating optionally further comprising an isocyanate based crosslinking agent.

13. The packaging, of claim 1, wherein said substrate is made or comprises a material selected from the group consisting of paper, paperboard, glass, metal or a polymeric material selected from the group consisting of polypropylene, polyethylene, polyethylene-polypropylene copolymers, polystyrene, polyethylene terephthalate and bioplastics selected from polyhydroxyalkanoates, polybutylene succinate, and polylactic acid, and mixtures of said polymeric materials.

14. The packaging of claim 1, wherein said coating is applied to provide a coating grammage from 0.01 to 20 g/sqm, referred to the dry coating.

15. The packaging of claim 1, wherein said substrate comprises a single or multi-layer film or sheet comprising or consisting of paper, paperboard, polypropylene, polyethylene, polyethylene-polypropylene copolymers, polystyrene, polyethylene terephthalate and bioplastics selected from polyhydroxyalkanoates, polybutylene succinate, and polylactic acid, and mixtures of said polymeric materials, optionally including a metallized layer.

16. The packaging of claim 1, wherein a coating layer is applied to a flexible substrate and the coating is heat sealable to enable sealing of the flexible substrate against itself or against other surfaces.

17. The packaging of claim 16 wherein the packaging is sealed in a tubular form with said coating on an inside of said tubular form.

18. The packaging of claim 1, wherein the coating is applied to a paper, paperboard or plastic substrate before the substrate is subsequently thermoformed.

19. The packaging of claim 1, wherein the coating is applied to a paper, paperboard or plastic substrate before the substrate is folded into a rigid or semi-rigid form.

20. The packaging of claim 1, wherein the substrate is an injection molded or extruded packaging structure obtained by injection molding or extruding a polymer blend comprising:
a polymer selected from the group consisting of polypropylene, polyethylene, polyethylene-polypropylene copolymers, ABS, polystyrene, polyethylene terephthalate and bioplastics selected from polyhydroxyalkanoates, polybutylene succinate, and polylactic acid, and mixtures thereof,
an anti-microbial agent selected from the group consisting of titanium, silver, gold, copper, platinum, zinc, an oxide or salt of said metals, alloys, glasses or clays comprising said metal oxides, anti-microbial peptides, silicone based anti-microbial agents, quaternary ammonium cations (Quats), a disinfectant selected from the group consisting of peroxides, propylene glycol, triethylene glycol, dodecanoic acid, formaldehyde, glutaraldehyde, thymol, clove oil, cinnamon oil, grape fruit seed extract, eucalyptus extract, anti-microbial plant extract, chlorine, or iodine solutions in solvents, wherein said disinfectant is optionally encapsulated within a heat, moisture or temperature sensitive polymeric material, and
a low adhesion, slip or release agent selected from the group consisting of silicone vinyl polymers, silicone emulsions, dimethyl polysiloxanes, silicone oils, silicone wax, carnauba wax, lecithin, fatty acids, fatty acid esters, magnesium stearate, vegetable oils selected from the group consisting of soybean oil, rapeseed oil, palm oil, sunflower oil, coconut oil, castor oil, and mixtures thereof.

21. The packaging of claim 20, wherein the substrate is an injection molded or extruded packaging structure obtained by injection molding or extruding a polymer blend comprising:
a polymer selected from the group consisting of polypropylene, polyethylene, polyethylene-polypropylene copolymers, ABS, polystyrene, polyethylene terephthalate, and bioplastics selected from polyhydroxyalkanoates, polybutylene succinate, and of polylactic acid, and mixtures thereof with a master batch comprising:
a polymeric component selected from the group consisting of polyurethanes, polyacrylic resins, polyethylene terephthalate, polyvinyl alcohols, polyhydroxyalkanoates, polylactic acid, cellulosic polymers, and mixtures thereof,
a low adhesion, slip or release agent selected from the group consisting of silicone vinyl polymers, silicone emulsions, dimethyl polysiloxanes, silicone oils, carnauba wax, lecithin, fatty acids, fatty acid esters, magnesium stearate, vegetable oils selected from the group consisting of soybean oil, rapeseed oil, palm oil, sunflower oil, coconut oil, castor oil, and mixtures thereof, and
an anti-microbial agent selected from the group consisting of titanium, silver, gold, copper, platinum, zinc, an oxide or salt of said metals, alloys, glasses or clays comprising said metal oxides, anti-microbial peptides, silicone based anti-microbial agents, quaternary ammonium cations (Quats), a disinfectant selected from the group consisting of peroxides, propylene glycol, triethylene glycol, dodecanoic acid, formaldehyde, glutaraldehyde, thymol, clove oil, cinnamon oil, grape fruit seed extract, eucalyptus extract, anti-microbial plant extract, chlorine, or iodine solutions in solvents, wherein said disinfectant is optionally encapsulated within a heat, moisture or temperature sensitive polymeric material.

22. The packaging of claim 20, wherein said substrate is an extruded packaging structure and said coating is coextruded with said substrate.

23. The packaging of claim 1, wherein the coating is applied to a rigid or semi-rigid packaging structure after the packaging structure is formed imparting anti-microbial properties.

24. The packaging of claim 1, further comprising an adhesion enhancing layer placed between the substrate and the coating, selected from the group consisting of a clay coating, a printed layer printed with printing inks, a barrier coating, and an acrylic primer.

25. A composition comprising:
a first polymeric component selected from the group consisting of polyacrylic resins, polyvinyl butyral and mixtures thereof,
a low adhesion, slip or release agent selected from polysiloxanes selected from the group consisting of silicone vinyl polymers, silicone emulsions, dimethyl polysiloxanes silicone oils, silicone wax, and mixtures thereof, and
an anti-microbial agent.

26. The composition of claim 25, wherein said anti-microbial agent is selected from the group consisting of titanium, silver, gold, copper, platinum, zinc, an oxide or salt of said metals, alloys, glasses or clays comprising said metal oxides, anti-microbial peptides, silicone based anti-microbial agents, quaternary ammonium cations (Quats), a disinfectant selected from the group consisting of peroxides, propylene glycol, triethylene glycol, dodecanoic acid, formaldehyde, glutaraldehyde, thymol, clove oil, cinnamon oil, grape fruit seed extract, eucalyptus extract, anti-microbial plant extract, chlorine, or iodine solutions in solvents, wherein said disinfectant is optionally encapsulated within a heat, moisture or temperature sensitive polymeric material.

27. A process for producing a packaging having anti-microbial properties, the process comprising applying a composition according to claim 25 to a packaging flexible or rigid substrate.

28. A process for producing a packaging having anti-microbial properties, the process comprising blending a composition according to claim 25 with a thermoplastic polymeric material and molding or thermoforming said blend to provide said packaging.
